(19) United States
(12) Patent Application Publication
(10) Pub. No.: US 2007/0262138 A1
(43) Pub. Date: Nov. 15, 2007

(54) Dynamic encryption of payment card numbers in electronic payment transactions

(76) Inventors: Jean Somers, Grivegnee (BE); Paul Vanneste, Ottignies (BE)

Correspondence Address: BAKER BOTTS L.L.P., 30 ROCKEFELLER PLAZA, 44TH FLOOR, NEW YORK, NY, 10112-4498, US

(21) Appl. No.: 11/396,441

(22) Filed: Apr. 3, 2006

Related U.S. Application Data
(60) Provisional application No. 60/667,881, filed on Apr. 1, 2005.

(51) Int. Cl. G06K 5/00

(52) U.S. Cl. 235/380

(57) ABSTRACT

Systems and methods are provided for secure transmission of information identifying account holders in electronic payment transactions made using payment cards or devices that are based integrated circuit chip technology. Individual cards or devices are associated with a cipher key. Information such as personal account numbers, which may be stored on the cards or devices, is encrypted using a block cipher in a variant of the cipher feedback mode. This manner of encryption preserves the length of the cleartext, and allows the ciphertext to be securely transmitted in standard data structure formats over legacy electronic payment networks.

### CROSS-REFERENCE TO RELATED APPLICATION

This application claims the benefit of U.S. Provisional Patent Application No. 60/667,881 filed on Apr. 1, 2005, which is hereby incorporated by reference herein in its entirety.

### BACKGROUND OF THE INVENTION

An electronic payment is any kind of non-cash payment that does not involve a paper check. Methods of electronic payments include payment by credit cards, debit cards and the ACH (Automated Clearing House) network. The ACH system comprises direct deposit, direct debit and electronic checks (e-checks).

Electronic payment is very convenient for the consumer. In most cases, the consumer enters account information—such as his or her credit card number and shipping address—on a web site once. Completing a transaction may be as simple as clicking a mouse to confirm a purchase. Electronic payment lowers costs for businesses. The more payments the businesses can process electronically, the less they spend on paper and postage.

Account information, which is relevant to the processing of an electronic payment, is often formatted to conform to industry-wide standards. For example, the account information contained in magnetic stripe cards is formatted in one of three tracks (Tracks 1, 2 and 3) under ANSI and ISO standards. For example, ANSI X4.16, “American National Standard for Financial Services—Financial Transaction Cards—Magnetic Stripe Encoding” defines the physical, chemical, and magnetic characteristics of the magnetic stripe on the card. The standard defines a minimum and maximum size for the stripe, and the location of the three defined encoding tracks. (See FIG. 1). FIGS. 2a and 2b show examples of the standardized data fields and layouts for Track 1 and Track 2, which are mandated by the ANSI/ISO standards. The Primary Account Number (PAN) associated with payment cards can be a number up to 19 digits. In accordance with the account numbering scheme in ISO 7812, PAN consists of the following parts:

I. Issuer Identification Number (IIN): up to 6 digits (e.g., the Bank Identification Number (BIN)—The first six digits of a Visa or MasterCard account number). This number is used to identify the card-issuing institution.

II. Individual Account Identification (IAI): up to 12 digits, which are assigned by the card issuer.

III. Check Digit (CD): 1 digit, which is calculated using the Luhn formula.

MasterCard uses a PAN which is variable up to 16 digits including the check digit, while VISA uses a PAN of 13 or 16 digits.

The main drawbacks to electronic payments using payment cards relate to concerns over privacy loss and the possibility of identity theft. Electronic payments typically rely on the transmission of sensitive data that identifies the specific customer or account holders. Examples of such data include the Primary Account Number (PAN) and the PAN Sequence Number (PSN) that are commonly associated with debit or credit cards. Compromise of the sensitive data can lead to fraudulent transactions. This is especially true when there is no provision for account holder authentication, e.g., through use of a Personal Identification Number (PIN). Furthermore, unauthorized or improper release of the sensitive data also raises privacy concerns. For example, improper release of card numbers may allow separate purchases made with the same card to be tracked down and potentially linked to an individual, which provides information on the individual's buying habits or location.

The exposure of sensitive payment data, and therefore the risk of fraud or of threat to privacy, has increased with the widespread use of new payment channels, e.g., payments over the Internet or payments based on contactless systems. On most of these channels, sensitive payment data such as the PANs and the related PSNs are transmitted in cleartext i.e. without cryptographic protection.

Consideration is being given to securing the transmission of sensitive payment data such as the PANs and the related PSNs in electronic payment schemes. In particular, attention is directed to systems and methods for protecting PANs and PSNs, which are compatible with existing payment transaction infrastructure, including payment terminals and payment networks.

### SUMMARY OF THE INVENTION

The present invention provides systems and methods for securing sensitive information that is transmitted between parties in an electronic payment transaction. The secured information may, for example, be the Primary Account Numbers (PAN) and the PAN Sequence Numbers (PSN) that are commonly associated with debit or credit cards. The inventive systems and methods are compatible with the existing payment transaction infrastructure including payment terminals and payment networks that are presently deployed in the field. Further, the inventive methods may be used with various transaction channels or payment schemes, including, for example, magnetic stripe transactions conducted with a chip card emulating magnetic stripe cards, Internet chip-based transactions, mail order/telephone order (MO/TO) chip-based transactions and other chip-based contactless transactions.

The inventive systems and methods keep sensitive data (e.g., account number in PAN) confidential during transmission by using encryption. Further, the encrypted PAN is varied at each transaction in an unpredictable way. Each encrypted PAN is usable only once. The encoding of transaction data may be accomplished in a manner that is compatible with existing merchant, acquirer and payment scheme infrastructure supporting magnetic stripe transactions. The only impact is at card issuer level.

The payment schemes benefit from the application of the inventive systems and methods in that sensitive transaction information such as PANs and the related PSNs are transmitted in a secure manner so that even if the data is exposed on a given channel, it cannot be used to conduct fraudulent transactions on that same channel (i.e., providing protection against direct fraud), or on other channels (i.e., providing protection against cross-contamination fraud). Further, the exposed data cannot be used to track down transactions conducted using the same card (i.e., providing privacy protection).

The inventive systems and methods for securing sensitive information are significantly different from classical pseudo-PAN systems for transition authorization. For example, they do not require a separate communication between the cardholder and the issuer for generating an encrypted PAN. In addition, no transaction context is stored at the issuer side.

### BRIEF DESCRIPTION OF THE DRAWINGS AND APPENDICES

FIG. 1 is a diagram illustrating the standard format of Tracks 1, 2, and 3 in magnetic stripe cards.

FIGS. 2A and 2B are illustrations respectively of standard magnetic stripe Track 1 and Track 2 data structure fields and layouts.

APPENDICES AA and AB illustrate basic PAN encryption and decryption processes, respectively, in accordance with the principles of the present invention.

APPENDICES AC and AD illustrate an optimized variant of the basic PAN encryption and decryption processes, respectively, in accordance with the principles of the present invention.

APPENDICES AE and AF illustrate another optimized variant of the basic PAN encryption and decryption processes, respectively, in accordance with the principles of the present invention.

FIG. 3 illustrates the implementation of the PAN encryption/decryption processes of APPENDICES AA-AF in an electronic payment network, in accordance with the principles of the present invention.

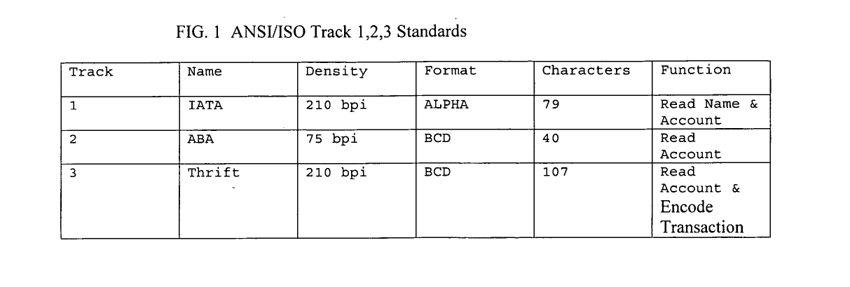

### DESCRIPTION OF THE INVENTION

Systems and methods are provided for securely transmitting sensitive transaction data over electronic payment networks involving multiple parties. The multiple parties may include, for example, cardholders, merchants, acquirers, card issuers and other entities that can be involved in a pay-by-card transaction or its authorization. The sensitive transaction data, which may include all or portions of a cardholder PAN and/or PSN, is differently encrypted for each transaction before transmission. The data encryption is conducted in manner, which is compatible with existing electronic payment infrastructure formats including standard magnetic stripe payment card formats.

An exemplary implementation of a sensitive data transmission system and method uses a block cipher type of symmetric-key encryption algorithm to transform fixed-length plaintext (unencrypted text) data into ciphertext (encrypted text) data of the same length. The encryption process may be conducted in an on-card chip in the payment card under the action of an issuer provided secret key. After transmission of the encrypted text, for example, to a card issuer, the encrypted text is decrypted by applying the reverse transformation to the ciphertext block using the same secret key.

The encryption may be performed in a standard DES mode (see e.g., FIPS 81 and ANSI X3.106 Standards). For example, the encryption of the payment card PAN, or a part thereof, for a specific transaction is performed using a block cipher in a variant of the Cipher Feedback (CFB) mode.

In the exemplary implementation, the encryption process is rendered dynamic by making it a time dependent function (e.g., a specific-transaction dependent function). The resulting encrypted PAN is made usable only once, i.e. for the specific transaction. This dynamic encryption of the payment card PAN offers both transaction replay protection and privacy protection. The encryption process may be made dynamic, for example, by making it a function of an updated or incremented transaction number in addition to being a function of an issuer-specific secret key. The updated transaction number may, for example, be a conventional on-card Application Transaction Counter (ATC) that is incremented at each transaction.

It will be understood that information about the ATC number associated with the transaction by the card has to be transmitted to the issuer for the purpose of PAN decryption. In practice, tracking the ATC of each card, for example, at an issuer authorization level, ensures that each ATC, and therefore each encrypted variant of the original card number (PAN), is used only once.

For security of the encrypted data, the card encryption key is not and need not be shared between the issuer and the merchant, the acquirer or the payment scheme involved in the transaction. However, the encryption key may be shared between an issuer and a range of cards. It will be understood that the same encryption key must be used for all cards that cannot be distinguished from each other using only unencrypted card data (for example, bank identification number (BIN) or service code).

In practice, the length of the PAN is preserved upon encryption by using a block cipher in a variant of the CFB mode in which digital digits are encrypted as decimal digits. The preservation of the length of the PAN is achieved by using a block cipher in a variant of the CFB mode, which is similar to, but not completely consistent with the mode of operation defined, for example, in ISO/IEC 10116. The inconsistency with the standard arises from the need to perform encryption in such a way that decimal digits are encrypted to decimal digits. Because the CFB encryption does not produce any expansion in the size of the encrypted PAN digits when compared to the original PAN, the encrypted PAN can be stored in the magnetic stripe data at the location of the digits that would normally record the original PAN. Therefore, the encoding is transparent for existing merchant, acquirer and payment scheme infrastructures for magnetic stripe transactions. CFB encryption is performed two times, first in one direction through the digits, a second time in the opposite direction. This completely conceals any shared digits between two PANs.

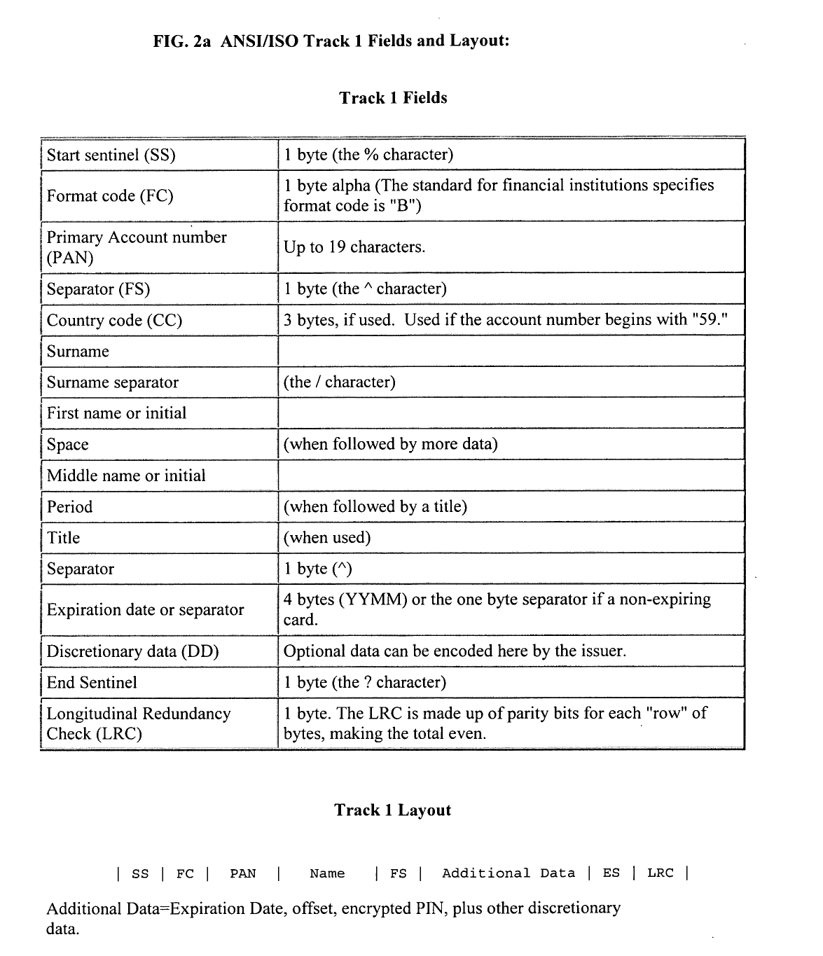

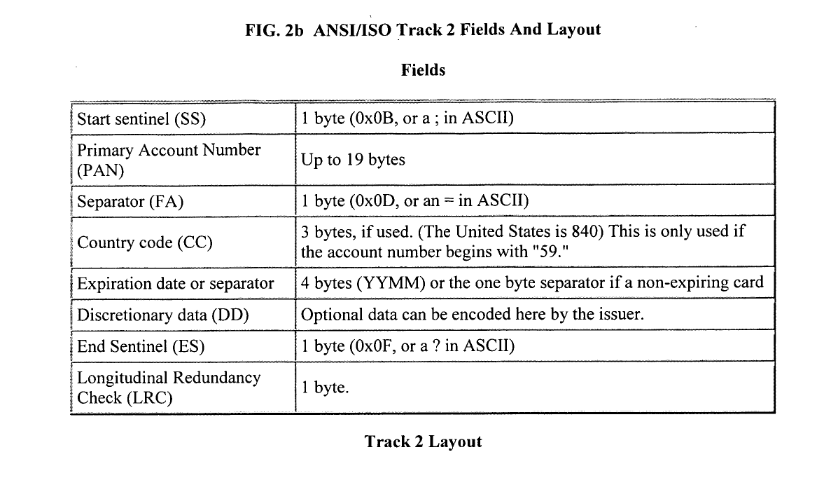

The CFB encryption does not produce any expansion of the size of the encrypted PAN digits when compared to the original PAN. Therefore, the encrypted PAN digits can be stored in standard format magnetic stripe track data structures at the same locations that are designated for storing the unencrypted PAN digits. (See e.g., FIGS. 2A and 2B). Further, information on the ATC number, which is transmitted to the issuer for the purpose of PAN decryption, also may be transmitted in standard magnetic stripe track data structures. For example, the digits of the ATC number may be stored in unused digits of the discretionary data (DD) fields of standard format magnetic stripe track data structures. Use of the standard format magnetic stripe track data structures for transmitting the encrypted sensitive data and any other required control data makes the encoding transparent to existing merchant, acquirer and payment scheme infrastructures that are commonly deployed for magnetic stripe card transactions.

It will be understood that in some implementations, an issuer may supply a common encryption key to a range of cards for PAN encryption. The cards may share several consecutive PAN digits that are processed in the beginning of the encryption process. In a theoretical situation when these cards have a same ATC value, the resulting encrypted PANs for the cards can have same digits, which creates the potential of some information leakage. However, it is expected that large-scale intrusive attacks will be difficult to mount. Also, even if the data is encrypted twice, in the situation where two cards share the same key, ATC value and share all PAN digits except for the final one, then the difference between the encrypted versions of this final digit will be equal to the difference between the cleartext versions of this final digit. Two encryption passes followed by an encryption of the final digit will remove any such problems.

In implementations using a common encryption key for a range of cards, or other implementations, additional encrypted PAN diversification can be obtained by making the encryption process a function of additional variables. For example, when some digits of the magnetic stripe DD fields are unused, the encryption process also may be made a function of those digits. The unused digits of the magnetic stripe DD fields may be assigned dynamic values, for example, by the payment card itself, or static values, for example, by the issuer when the card is personalized. These digits can contribute to card diversity and hence to encrypted PAN diversification.

Further, in practice, after having computed the encrypted PAN, the payment card populates an “encrypted PAN” data structure that is similar to a standard format magnetic stripe data structure (e.g., Track 1 or Track 2 data structure). The encrypted PAN is used to populate the account number digits in the PAN data field. The card also may recompute the Luhn Check Digit (CD), but leaves the BIN untouched. The digits of the ATC and when applicable the DD digits used for encrypted PAN diversification may be used to populate part of the DD field. The other magnetic stripe data structure fields may be taken from a card-stored template. The encrypted PAN data structure is provided to the merchant or other transaction terminals that are designed to process magnetic stripe card data.

The encrypted PAN data structure may be transmitted by the terminal to an appropriate authority (e.g., an issuer host server) over the electronic payment network for authorization, validation or authentication of the transaction. The host server recovers the ATC used by the card from the ATC digits in the payment card's magnetic stripe DD fields. When applicable, the host server also recovers the digits used for encrypted PAN diversification from the payment card's magnetic stripe DD fields. The issuer host server also recovers from memory the particular card key associated with the particular payment card based up on suitable unencrypted data on in magnetic stripe data structure (e.g., BIN data). Using these three data elements, namely, the ATC, the optional DD diversification digits and the particular encryption key, the host serve can decrypt the encrypted PAN to recover the original PAN associated with the particular payment card. The recovered PAN may then be used for any suitable authorization or clearing process. A suitable authorization or clearing process includes, for example, processes that are based on validation of card verification numbers (CVN validation).

It may be noted that with block ciphers, a full ciphertext is required for a correct decryption. Therefore, the direct use of a DES-like block cipher is inappropriate for account number/PAN encryption. The inappropriateness arises because of the fixed size of cipher input/output blocks (e.g., 64 bits) the encrypted PAN ciphertext would be expanded with respect to the size of the original PAN, and the magnetic stripe data fields available for storing the encrypted result are usually shorter than the resulting ciphertext.

In contrast, the inventive encryption processes, which may be performed using a block cipher in a variant of the Cipher Feedback (CFB) mode, transform a fixed-length block of plaintext (unencrypted text) data into a block of ciphertext (encrypted text) data of the same length (e.g., 12 digits).

APPENDIX AA shows a pseudo-code algorithm implementation of a basic encryption process 330, which is based on the variant use of a standard block cipher (e.g., DES3). Further, APPENDIX AB shows a corresponding decryption process 340, which is the converse of encryption process 330.

The basic implementation requires 2.r+1 DES3 operations for each PAN encryption/decryption operation, where r is the number of PAN digits to be encrypted, with r>1. For example, when the card PAN is 16 digits long (including the Luhn check digit) and the BIN, which is to be kept unencrypted for routing purposes, is 6 digits long, then 19 DES3 operations will have to be performed for each PAN encryption/decryption operation. It is noted that basic encryption process 330 does not require formal use a full 64-bit addition. However, a sufficient number of bits of the DES3 output should be used, to reduce any statistical irregularities in the result of the addition. It may be preferable to use at least 16-bit addition. Decryption process 340 can be correspondingly adapted.

The generic implementation may require a large number of DES3 operations for each PAN encryption/decryption. The processing time of the encryption/decryption processes can be optimized, for example, by processing PAN digits in groups instead of processing them one at a time. APPENDIX AC shows an optimized encryption process 350 which processes subsets or groups of PAN digits. Process 350 requires only 5 DES3 operations for each PAN encryption/decryption operation. APPENDIX AD shows decryption process 360 corresponding to optimized encryption process 350.

APPENDIX AE shows encryption process 370, which is another optimized version of process 330. APPENDIX AF shows a corresponding decryption process 380. Encryption process 370 combines encryption operations and replaces the shift in cipher feedback by a simple XOR operation to improve performance. Encryption process 370 has a structure, which is similar to a 3-round Feistel cipher, requires only 3 DES3 operations for each PAN encryption/decryption operation.

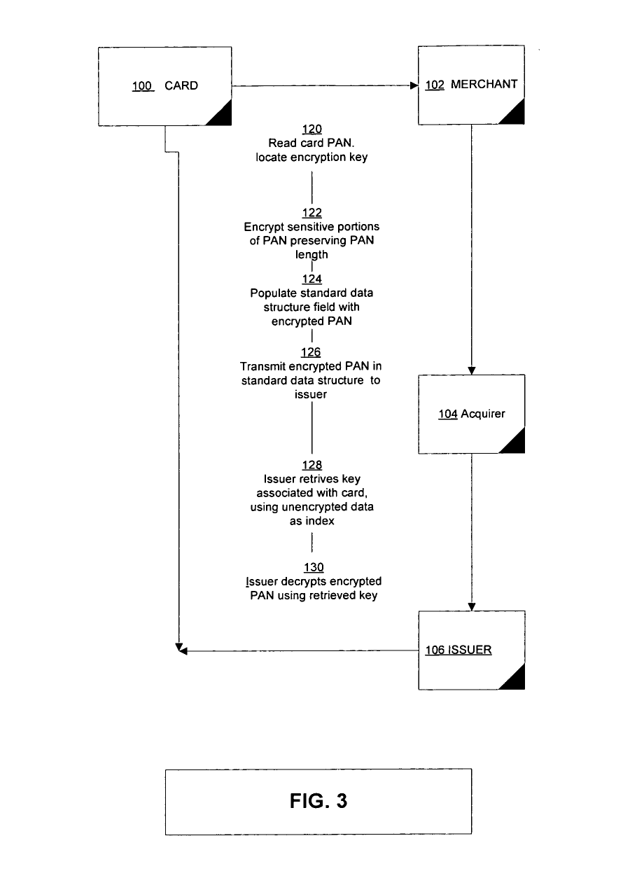

FIG. 3 shows a generic electronic payment network implementation of the encryption/decryption processes (e.g., processes 330-380) for a payment transaction 110, which involves card 100, merchant 102, and issuer 106. The electronic payment network may optionally involve an acquirer 104. At an initial step 120 of payment transaction 110, the card PAN number is read. The PAN number may include a BIN number and a cardholder account number assigned to a particular cardholder by the issuer 106. Next at step 122, the personally identifying information in the PAN (e.g. the cardholder account number) is encrypted, using for example, encryption process 310. An encryption key (not shown) assigned by issuer 106 to card 100 is used for encryption. Certain non-sensitive portions of the PAN (e.g., BIN) are not encrypted and left untouched. However, the Luhn check digit may be recomputed. At step 124, a magstripe compatible data structure is populated with the encrypted PAN. At step 126, the encrypted PAN is transmitted via the merchant 102 and optionally via acquirer 104 to issuer 106. At step 128, issuer 106 retrieves from memory the particular encryption key assigned to card 100 using, for example, the unencrypted BIN data for indexing. At step 130, issuer 106 decrypts the received encrypted PAN using, for example, decryption process 132. Issuer 106 then uses the decrypted PAN for transaction authorization/validation processing, which may be conventional.

For implementing the PAN encryption/decryption processes (e.g., processes 330-380, APPENDICES AA-AF), a card issuer can choose from a number of options when initializing a payment card. These options include:

A. The value of k. The value of k should be chosen as small as possible, to maximize the number of digits concealed by encryption while ensuring proper transaction routing. A value for k larger then strictly necessary may be used in order to allow for IK selection from a larger key set.

B. The value of s. The value of s should be chosen as large as possible subject to system constraints. The greater the value of s, the less the probability that two IVs will be the same, hence choosing a larger value for s reduces the risk of card number compromise. Typically a minimum value of s=2 is recommended, requiring 4 available digits in the magnetic stripe discretionary data.

C. The means to be used to generate the 2.s SPARE digits. There are two main possibilities for generating these digits. They can either be chosen by the issuer at the time of card issue, or randomly chosen by the card for each transaction. Each approach has its own advantages. Use of dynamic, randomly-generated SPARE digits improves privacy protection by making the linking of transactions belonging to the same card more difficult. Use of static SPARE digits allows the issuer to perform key selection, for instance by dynamically deriving card keys from an expiry-date-specific master key and from the BIN and SPARE digits, using an appropriate secure key derivation function. The latter approach is recommended. Using a combination of dynamically-generated and statically-generated SPARE digits might also be used, but this solution does not bring any significant advantage.

D. The choice of the secret key IK. Each secret IK should be randomly generated or derived from a randomly generated master key using, for instance, the BIN and expiry date as derivation parameters. At minimum, each BIN and expiry year should be allocated a different secret key. It is recommended that, if the SPARE digits are fixed at the time of card issue, these digits are used for key derivation and selection by the issuer. Each secret key IK should be held securely by the card issuer.

The inventive systems and methods for securely transmitting sensitive data can be adapted to various payment schemes including Contactless Payment Transactions, Magnetic Stripe Payment Transactions which are performed using chip cards that emulate magnetic stripe cards, and Remote Payment Transactions. The latter may include Chip-based Internet Payment Transactions, Classical Internet Payment Transactions, and MO/TO Payment Transactions. Further, the various payment schemes may be based any type of smart payment card that contain an embedded integrated circuit chip. A “contact” smart card may have metal contacts connecting the card physically to a reader, while a ‘proximity’ or ‘contactless’ smart card may use a magnetic field or radio frequency (RFID) for close-proximity reading. A ‘hybrid’ smart card may include a magnetic stripe in addition to the chip. The hybrid cards are common in payment cards, as that the cards are then compatible with payment terminals that do not include a smart card reader.

Contactless Payment Transactions

Because of the over-the-air nature of their interface to the payment terminals, contactless payment transactions may be vulnerable to intrusion and are especially security sensitive. This is made worse by the fact that contactless payment transaction processing usually avoids cardholder authentication steps in order to preserve transaction speed. The inventive PAN encryption/decryption processes (e.g., FIG. 3) may be advantageously utilized for contactless payment transaction processing for transaction replay protection and privacy protection.

Commercial contactless payment cards (such as MasterCard PayPass™ or American Express ExpressPay) are designed to produce data whose structures and formats are similar to standard magnetic stripe data. This allows re-use of existing magnetic stripe transaction infrastructure, including payment terminals and payment networks, with only a minimal impact at terminal level. For example, MasterCard PayPass™ cards generate ISO2 (track 2) magnetic stripe compatible standard data structures. (See e.g., PayPass—Mag Stripe Technical Specifications (Version 3.1, November 2003), PayPass—ISO/IEC 14443 Implementation Specification (Version, June 2004) and the ISO/IEC 14443 Standards). The commercial contactless payment cards also usually feature a card-specific ATC, which is incremented at each transaction and is transmitted in the DD fields of magstripe data structures.

The PAN encryption/decryption processes (APPENDICES AA-AF) for transmission of sensitive data may be implemented in the following way:
SPARE is set at card personalization time as a number assigned sequentially or randomly to each card and is available at issuer known location in the DD template.
ATC is set to the value of the ATC used by the card to perform the current transaction.
ENCPAN is used to populate the area of the card where the card PAN is stored so that it can be read by a suitable PayPass terminal command.

It is expected that the impact of the PAN encryption/decryption processes on the existing contactless card application will be minimal.

Magnetic Stripe Payment Transactions

Electronic payment schemes in which payment chip cards emulate magnetic stripe card by dynamically generating suitable magnetic fields when swiped through magnetic stripe payment terminals or readers have been proposed. (See e.g., Blossom, U.S. Pat. No. 6,631,849). The inventive PAN encryption/decryption processes ((APPENDICES AA-AF)) may be advantageously utilized in the magnetic stripe card emulation based payment schemes to protect against fraudulent merchants in a manner similar to that described above.

Remote Payment Transactions

(a) Chip-based Internet Payment Transactions

Internet payment systems may be based on the use of payment chip cards for the generation of authentication tokens. See e.g., Davis et al. U.S. Pat. No. 6,282,522. The authentication token verification process requires a card-generated ATC to be transmitted within the token. Payment chip cards that are EMV specification compliant have provision for on-card ATC generation.

In some of the Internet payment systems, the chip card may act as an agent of the issuer, in which case there is no need for establishing a connection to transmit sensitive data between the cardholder system and an issuer-operated server. See e.g., Fikret Ates U.S. Patent Application Publication No. US2005119978. However, in general, the Internet payment systems expose payment card data including card PANs during transmission of transaction processing data over the Internet to the card issuer.

The inventive PAN encryption/decryption processes (APPENDICES AA-AF) may be advantageously utilized in chip-based Internet payment systems to protect sensitive data in the following way:
SPARE is not used (i.e. s is set to 0).
A TC is set to the value of the ATC used by the card to perform the current transaction.
ENCPAN is used to populate an area of the card where the card PAN is stored so that it can be read by an existing or an additional terminal command.

The payment application running on the cardholder platform or the cardholder card reader uses this existing or additional terminal command to retrieve the encrypted PAN from the card memory. The encrypted PAN then may be either displayed (e.g., for manual entry in a payment form by the cardholder) or automatically filled in the payment form.

(b) Classical Internet Payment Transactions and MO/TO Payment Transactions

The inventive PAN encryption/decryption processes (e.g., processes 330-380) also may be advantageously utilized to secure sensitive data in classical internet payment transactions and MO/TO payment transactions. In exemplary implementations, cardholders have at their disposal card readers having suitable user interfaces with input/output capabilities. A suitable card reader with input/output capabilities may be a stand-alone card reader (e.g., featuring a keypad and display), or may be a combination of a PC application and a standard card reader. For processing a transaction, the suitable card reader interacts with the card to obtain the encrypted PAN and the digits of the ATC, and displays these to the cardholder.

The cardholder may transfer the displayed encrypted PAN and ATC digits (e.g., manually) into a classical Internet payment form. The encrypted PAN may be used to populate a PAN field in the classical Internet payment form. The ATC may be used to populate the 3- or 4-digits security code data field (e.g., CVV2, CVC2, or CID data field), which is typically transmitted as part of a MO/TO transaction. Up to three digits for the ATC data required for decryption may be conveyed by a 3-digit CVC2 field.

It is noted that using the security code data field (e.g., CVC2 data field) for transmitting ATC digits may make the payment system vulnerable to attacks. For example, an intruder may submit a random encrypted PAN for authorization. It is at least theoretically possible that the decryption process will recover a PAN that is random but which matches a genuine PAN. The security risk may be minimized by keeping the number of ATC digits transmitted as small as possible and retaining a part of the CVC2 data field to transmit a part of the CVC2. For example, the 3-digit CVC2 field could be filled in with 2 digits from the original CVC2 and 1 digit from the ATC.

It will be understood that the foregoing is only illustrative of the principles of the invention, and that various modifications can be made by those skilled in the art without departing from the scope and spirit of the invention. For example, although the chip card may be the preferred platform for obvious tamper resistance reasons, the encryption/decryption processes for securely transmitting sensitive transaction data may be implemented on other platforms, for example, personal computers, mobile phones or any personal device having processing capabilities.

1. A method for conducting a payment-by-card transaction over an electronic payment network which links an issuer of a payment card, a merchant and a cardholder, wherein the payment card has a primary account number (PAN) that includes a fixed number of digits associated with an Individual Account Identification (IAI) number and other digits associated with an Issuer Identification Number (IIN) and a Check Digit (CD), the method comprising:
obtaining an issuer-provided encryption key;
using the issuer-provided encryption key to encrypt the PAN in a manner so that the encrypted PAN (UNCPAN) has the same length as the unencrypted PAN;
transmitting the encrypted PAN over the electronic payment network to the issuer of the payment card;
decrypting the encrypted PAN received at the issuer to recover the unencrypted PAN; and
using the recovered PAN at the issuer to process the transaction.

2. The method of claim 1 wherein using the issuer-provided encryption key to encrypt the PAN in a manner so that the encrypted PAN has the same length as the unencrypted PAN comprises using a block cipher type of symmetric-key encryption algorithm to transform a fixed-length block of plaintext into a block of ciphertext of the same length independent of the encryption algorithm block size.

3. The method of claim 1 wherein using the issuer-provided encryption key to encrypt the PAN in a manner so that the encrypted PAN has the same length as the unencrypted PAN is conducted in an on-card chip in the payment card under the action of the issuer-provided encryption key.

4. The method of claim 1 wherein using the issuer-provided encryption key to encrypt the PAN in a manner so that the encrypted PAN has the same length as the unencrypted PAN comprises using a block cipher in a variant of the Cipher Feedback (CFB) mode, which involves encrypting a subset of the PAN digits at a time.

5. The method of claim 1 wherein using the issuer-provided encryption key to encrypt the PAN in a manner so that the encrypted PAN has the same length as the unencrypted PAN comprises encrypting the PAN at each transaction in an unpredictable way so that the unencrypted PAN is useable only once.

6. The method of claim 5 wherein encrypting the PAN at each transaction in an unpredictable way comprises encrypting the PAN as a function of automatic transaction counter (ATC) number, which is incremented at each transaction.

7. The method of claim 1 wherein using the issuer-provided encryption key to encrypt the PAN in a manner so that the encrypted PAN has the same length as the unencrypted PAN comprises encrypting the Individual Account Identification (IAI) digits.

8. The method of claim 7 further comprising comprises recomputing the Check Digit (CD).

9. The method of claim 7 wherein the payment card comprises a discretionary data (DD) field, and wherein the method further comprises encrypting at least one digit in the DD field for diversification of the encrypted data.

10. The method of claim 9 wherein the payment card dynamically assigns a value to at least one digit in the DD field.

11. The method of claim 9 wherein the payment card issuer assigns a static value to at least one digit in the DD field.

12. The method of claim 1 further comprising storing the encrypted PAN digits in a standard format magnetic stripe track data structure at the same locations that are designated for storing the unencrypted PAN digits, and transmitting the standard format magnetic stripe track data structure over the electronic payment network to the issuer of the payment card.

13. The method of claim 12 further comprising storing the digits of an ATC number in a DD field of the standard format magnetic stripe track data structure and transmitting the standard format magnetic stripe track data structure over the electronic payment network to the issuer of the payment card.

14. A method for conducting a payment-by-card transaction over an electronic payment network which links an issuer of a payment card, a merchant and a cardholder, wherein the payment card has a primary account number (PAN) that includes a fixed number of digits associated with an Individual Account Identification (IAI) number and other digits associated with an Issuer Identification Number (IIN) and a Check Digit (CD), the method comprising:
obtaining an issuer-provided encryption key;
using the issuer-provided encryption key to encrypt the PAN in a manner so that the encrypted PAN (UNCPAN) has the same length as the unencrypted PAN;
displaying the encrypted PAN to the cardholder for entry in an on-line order form;
transmitting the encrypted PAN in the on-line order form over the electronic payment network to the issuer of the payment card;
decrypting the encrypted PAN received at the issuer to recover the unencrypted PAN; and
using the recovered PAN at the issuer to process the transaction.

15. The method of claim 14 wherein using the issuer-provided encryption key to encrypt the PAN in a manner so that the encrypted PAN has the same length as the unencrypted PAN comprises encrypting the PAN at each transaction in an unpredictable way so that the unencrypted PAN is useable only once.

16. The method of claim 15 wherein encrypting the PAN at each transaction in an unpredictable way comprises encrypting the PAN as a function of an application transaction counter (ATC) number.

17. The method of claim 16 further comprising displaying the digits of the ATC to the cardholder for entry in an on-line order form and transmitting the digits of the ATC in the on-line order form over the electronic payment network to the issuer of the payment card.

18. The method of claim 17 wherein the low-order digits of the ATC are used to populate a security code data field.
